(19) United States
(12) Patent Application Publication
(10) Pub. No.: US 2022/0126411 A1
(43) Pub. Date: Apr. 28, 2022

(54) A WEIGHT BALANCING GANTRY

(71) Applicant: Clem CUSCHIERI, Beverly Hills (AU)

(72) Inventor: Clem CUSCHIERI, Beverly Hills (AU)

(21) Appl. No.: 17/310,165

(22) PCT Filed: Feb. 11, 2020
(86) PCT No.: PCT/AU2020/050108

§ 371 Date: Jul. 22, 2021

(30) Foreign Application Priority Data
Feb. 11, 2019 (AU) 2019900436

(51) Int. Cl. B23Q 1/00; B23K 11/11; B23K 11/31; B23K 37/02; B23Q 11/00; B66C 23/48; B66C 23/72

(52) U.S. Cl. CPC B23Q 1/0054; B23K 11/11; B23K 11/318; B23K 37/0235; B66C 23/72; B23K 37/0294; B23Q 11/001; B66C 23/48; B23K 37/0282

(57) ABSTRACT

A weight balancing gantry has a tower having a fixed length radial arm pivotally coupled from a pivot point at an upper end of the tower. An angle strut acts between the tower and the radial arm across the pivot point. A pivot point pulley is located at the upper end of the tower and a weight balancing mechanism located at the tower. A bogey runs along the radial arm and has a bogey pulley. A positioning mechanism at the radial arm has at least one controlled cylinder for positioning and holding the bogey along to the radial arm. A cable runs from the weight balancing mechanism, up across the pivot point pulley and over the bogey pulley to attach to an industrial tool.

### FIELD OF THE INVENTION

This invention relates generally to a type of weight balancing gantry for balancing industrial tools, such as spot-welding guns.

### BACKGROUND OF THE INVENTION

Weight balancing gantries are used in industry to vertically balance the weight of industrial tools, such as spot-welding guns in the car repair industry. The weight of these tools can range from 10-25 kgs depending on arm size used, making them heavy and awkward to use without the assistance of a weight balancing gantry.

U.S. Pat. No. 2,176,979 A (Platz) 24 Oct. 1939 discloses a typical weight balancing gantry arrangement comprising a horizontal radial arm supported from a tower. A bogey runs along the horizontal radial arm and has pneumatic counterbalancing mechanism thereon from which a spot-welding gun is vertically balanced from a cable.

U.S. Pat. No. 6,087,611 A (De Bruyn et al.) discloses a system for vertically balancing welding tongs which comprises a spring balance attached from a horizontal radial arm for supporting the welding tongs from a cable. In a similar manner as that taught by Platz, the spring balance can run along the horizontal radial arm to various horizontal positions.

However, when welding within the beaver panel (section under the boot lid and boot floor) of a vehicle for example, the cable may be obstructed by the boot lid. Furthermore, the height of the roof of the vehicle may be too high for the radial arm.

As such, a need exists for an improved weight balancing gantry which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

There is provided herein a weight balancing gantry comprising a tower having a fixed length radial arm pivotally coupled from a pivot point at an upper end thereof. An angle strut acts between the tower and the radial arm across the pivot point to adjust the angle of the radial arm with respect to the tower. The pivot point pulley is located at the upper end of the tower.

The gantry may be supported from an industrial cart and the gantry supports an associated industrial tool from the radial arm. The industrial cart may be a mobile spot welder and the industrial tool may be a spot-welding gun.

The gantry further comprises a weight balancing mechanism which may comprise pneumatically biased opposing pulleys.

Furthermore, the gantry comprises a positioning mechanism at the radial arm comprising at least one controlled cylinder for positioning and holding the bogey along the radial arm.

The cable is run from the weight balancing mechanism, up across the pivot point pulley and over the bogey pulley to attach to the industrial tool for the balancing thereof.

The length of the cable is determined such that, in the manner shown in FIG. 1, when the positioning mechanism is retracted, the length of cable between the bogey pulley and the industrial tool is lengthened so as to position the industrial tool at a lower proximal stowed position. The industrial cart may comprise a toolholder such that, when the industrial tool is at the lower proximal stowed position, the industrial tool can be easily be placed in the holder.

However, when the positioning mechanism is extended, the length of cable between the bogey pulley and the industrial tool shortens to move the industrial tool to a distal raised deployed position.

In the manner shown in FIG. 2, the radial arm can be raised by the angle strut to hoist the industrial tool over a high obstacle, such as a vehicle roof. When the radial arm is inclined at an angle in this way, the at least one cylinder of the positioning mechanism holds the bogey in place along the radial arm and prevents the bogey from running down the radial arm.

In the manner shown in FIG. 3, the radial arm may be lowered, and the bogey positioned at a distal end of the arm to reach under an overhanging obstacle such as vehicle boot when working on the beaver panel for example.

Furthermore, the fixed length radial arm having the bogey travelling therealong, simplifies the construction of the radial arm and increases the resilience and weight bearing structural integrity thereof.

The weight balancing mechanism may comprise collinear cylinders to reduce the width of the tower.

Furthermore, the positioning mechanism may comprise two cylinders acting in series wherein a piston rod of a proximal cylinder of the positioning mechanism is connected to the cylinder tube of a distal cylinder of the positioning mechanism so that the bogey can be brought close to the tower, such as, for example, for placing the spot welder in a holder of the industrial cart.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a weight balancing gantry in accordance with an embodiment;

FIG. 2 illustrates the raising of a radial arm of the gantry to reach over high objects; and

FIG. 3 illustrates the lowering of the radial arm of the gantry to reach under objects.

### DESCRIPTION OF EMBODIMENTS

A weight balancing gantry 100 comprises a tower 101 having a radial arm 102 pivotally coupled from a pivot point 104 at an upper end of the tower 101 for supporting an industrial tool 109 such as a spot-welding gun.

The gantry 101 may be supported from an industrial cart 113 having castor wheels 114, such as a mobile spot welder.

An angle strut 116 acts between the tower 101 and the radial arm 102 across the pivot point 104.

In embodiments, the radial arm 102 may further swing side to side.

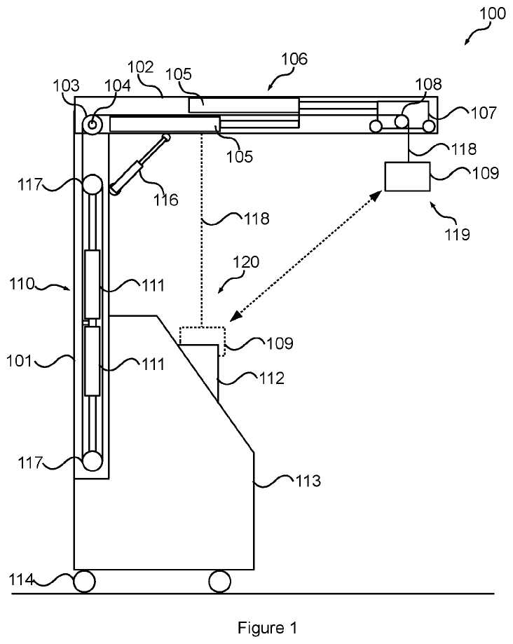

The gantry 100 comprises a weight balancing mechanism 110 which may comprise counteracting weight balancing pulleys 117. Each pulley 117 may be pneumatically biased from respective pneumatic cylinders 111, preferably in-line in the manner shown in FIG. 1 to reduce the overall width of the tower 101. In the embodiment shown, the weight balancing mechanism 110 is concealed within the tower 101.

In an embodiment, the balancing mechanism 110 may comprise a cheaper spring balancer as opposed to the pneumatic balancing cylinders.

A bogey 107 runs along the radial arm 102 between proximal and distal positions and supports a bogey pulley 108. The bogey 107 may run within an interior of the radial arm 102 in embodiments. A pivot point pulley 103 is located between the tower 101 and the radial arm 102, preferably coaxial with the pivot point 104.

The positioning mechanism 106 may comprise at least one controlled cylinder 105 which acts between the radial arm 102 and the bogey 107 to position and hold the bogey 107 at various positions along the radial arm 102.

The at least one cylinder 105 may be a pneumatic cylinder but, in alternative embodiments, may be hydraulic for increased positional stability, especially when the radial arm 102 is at an angle.

As spot welder guns already have an air supply (to allow the electrodes in the gun to squeeze the metals therefrom for welding), the air supply may be routed to the at least one cylinder of the positioning mechanism 106 by an offtake. As such, when the industrial tool is activated, the positioning mechanism automatically extends. A one-way valve may interface the offtake such that, should the air supply the accidentally disconnected, the positioning mechanism 106 remained extended.

A pneumatic toggle switch may allow forward and backward control of the at least one cylinder 105 of the positioning mechanism 106. When the toggle switch is opened, the cylinders 105 extend and are held extended by a pressure against gravity and cable tension.

Typically however, the toggle switch may only allow positioning between fully extended and fully retracted positions and, as such, in an embodiment, a control solenoid may be employed for inching control can be achieved should cylinder positioning be required.

A cable 118 may be run from between the cylinders 111 of the balancing mechanism 110, over the upper weight balancing pulley 117, down round the lower weight balancing pulley 117, up across the pivot point pulley 103, across to the bogey pulley 108 and down to support the industrial tool 109 at a distal end thereof.

In the embodiment shown, a pair of cylinders 105 act in series along the radial arm 102. In embodiments shown, the piston rod of the proximal cylinder 105 is connected to the cylinder tube of the distal cylinder 105 such that the cylinders 105 can assume contracted length substantially equal to that of one of the cylinder tubes, especially helpful when positioning the tool 109 into a toolholder on the cart 113.

With reference to FIG. 1, the length of cable 118 is determined such that, when the cylinders 105 of the positioning mechanism 106 are retracted, the length of cable 118 between the bogey pulley 108 and the industrial tool 109 is lengthened so as to hold the tool 109 at a lower proximal stowed position 120. However, when the cylinders 105 of the positioning mechanism 106 are extended, the length of cable 118 between the bogey pulley 108 and the industrial tool 109 shortens so as to hold the tool 109 at an upper distal position 119 at the end of the radial arm 102 ready for use.

In embodiments, the cart 130 may comprise a toolholder 112 which corresponds generally with the lower proximal stowed position 120. As such, when the positioning mechanism 106 is retracted, the industrial tool 109 may be easily placed within the toolholder 112.

In an embodiment (not shown) the tower 101 may be extendable in comprising a height adjustment mechanism comprising a cylinder 112 acting between a base piece 113 and an upper moveable telescopic piece. The height adjustment mechanism may be used in conjunction was alternative to the pivoting radial arm 102 wherein, for the latter, the radial arm 102 can be fixed at a right angle and height can be adjusted using the height adjustment mechanism. The height adjustment mechanism may be controlled by a linear actuator as opposed to a cylinder for torque and lock enhancement. Similarly, the linear actuator may be used for the angle strut 116 as opposed to a cylinder for enhanced angle control and lockability.

Where the angle strut 116 comprises a gas strut, the angle strut 116 may be lockable for holding the radial arm 102 in place at a certain height.

In embodiments angle strut 116 may comprise remotely controlled pneumatic cylinder, preferably controlled from the industrial tool 109.

The gantry 100 may comprise controllers accessible at the industrial tool 109 (wired or wireless) to control actuators for the angle strut 116 and positioning mechanism 106.

Furthermore, pressure within a pressure tank operably coupled to the pneumatic cylinder 111 of the weight balancing mechanism 110 may be adjusted (either manually or using an actuator) to match the weight of the industrial tool 109.

A separate supply from the same air supply source may be connected to the balancing cylinders 111 and finally to the pressure tank from a one-way valve and an air adjusting valve for adjusting tension the tension of the cable 118.

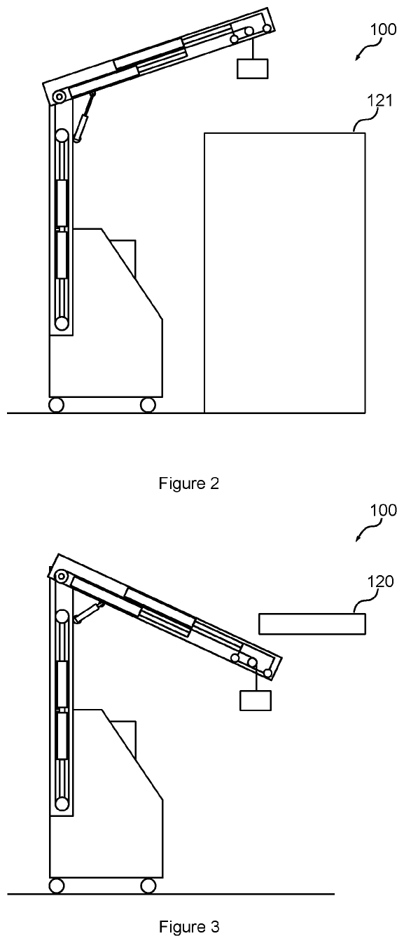

As such, in the manner shown in FIG. 2, the radial arm 102 may be raised by controlling the angle strut 116 to avoid an elevated obstacle 121. The cylinders 105 of the positioning mechanism 106 hold the bogey 107 in place along the radial arm, preventing the bogey 107 from sliding down the radial arm 107.

In the manner shown in FIG. 2, the radial arm 102 may be raised to reach over high obstacles 121 and lowered in the manner shown in FIG. 3 to reach under overhanging obstacles 120.

In embodiments, where the angle strut 116 comprises a gas strut, the angle strut expands at the force rating thereof. A spring-loaded pin in the strut 116 may be pushed by a pivoting lever handle to lock the strut 116 at different positions. When the lever is pulled, the strut 116 may be released up to the maximum stroke thereof. A handle of the lever may be at one end of the strut 116 mounted on a bracket on the tower and the handle may be pushed and held in a downward position to release the lock to allow movement of the arm 102 in either direction then released to hold it at the desired angle.

The force rating of the strut 116 may be such that when the tool 109 is at the proximal position 120, the force rating may be sufficient to raise the radial arm to the maximum angle thereof when the strut 116 is unlocked. Conversely, when the tool 109 is at the distal position 119, the force rating may be insufficient such that the radial arm 102 lowers.

As such, the raising and lowering of the radial arm 102 may be controlled by the position of the bogey 107.

When raising the radial arm 102, the positioning mechanism 106 may be retracted and the tool 109 placed in the holder 112 where after the strut 116 may be unlocked to raise the radial arm 102.

However, as the length of cable 118 may position the tool 109 beneath the holder 112 because the radial arm 102 is lowered and thereby requiring the operator to lift the tool, as an alternative, to allow support of the weight of the tool 109 all the way to the holder 112, the operator may push the radial arm 102 up at the same time while retracting the positioning cylinders such that, when the tool 109 reaches the holder 112, the radial arm 102 will already be at the highest position thereof.

As the lever to unlock the strut 116 may be spring loaded (i.e., in that the handle thereof needs to be held down to unlock the strut 116), it may be difficult to hold the tool 109 up and the lever down simultaneously, especially when the operator is at the distal end away from the lever.

As such, the mechanism to unlock the strut 116 may be modified to hold the strut 116 unlocked wherein the handle may be pushed down and then inward to be held in place. The radial arm 102 can now be automatically raised from is lower position by the force of the strut 116 while it is unlocked by simply retracting the positioning cylinders, shifting the weight of the tool 109 back toward the pivotal end, completely supporting the weight of the tool 109 all the way to the holder. The operator then pulls the lever outward to then relock the strut 116.

If a remotely controlled pneumatic cylinder (coupled with a standard gas strut for assistance) is used for the angle strut 116 the height of the radial arm 102 may be adjusted when the tool 109 is at the distal end of the radial arm 102.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

The term “approximately” or similar as used herein should be construed as being within 10% of the value stated unless otherwise indicated.

1. A weight balancing gantry comprising a tower having a fixed length radial arm pivotally coupled from a pivot point at an upper end of the tower, an angle strut acting between the tower and the radial arm across the pivot point, a pivot point pulley located at the upper end, a weight balancing mechanism located at the tower, a bogey running along the radial arm, the bogey comprising a bogey pulley, a positioning mechanism at the radial arm comprising at least one controlled cylinder for positioning and holding the bogey along to the radial arm and a cable running from the weight balancing mechanism, up across the pivot point pulley and over the bogey pulley to attach to an industrial tool, and wherein the length of the cable is determined such that when the positioning mechanism is retracted, the length of cable between the bogey pulley and the industrial tool lengthens so as to position the industrial tool at a lower proximal stowed position and, when the positioning mechanism is extended, the length of cable between the bogey pulley and the industrial tool shortens to move the industrial tool to a distal raised deployed position.

2. The weight balancing gantry as claimed 1, wherein the tower is supported from an industrial cart and wherein the industrial cart comprises a toolholder that coincides substantially with the lower proximal stowed position such that the industrial tool can be easily be placed in the holder.

3. The weight balancing gantry as claimed 1, wherein an air supply for the industrial tool is routed to the at least one controlled cylinder of the positioning mechanism by an offtake such that when the industrial tool is activated with the air supply, the at least one controlled cylinder automatically extends the positioning mechanism.

4. The weight balancing gantry as claimed 3, further comprising a one-way valve interfacing the offtake and the control cylinder such that, should the air supply be accidentally disconnected in use, the positioning mechanism remains extended.

5. The weight balancing gantry as claimed 3, further comprising a pneumatic toggle switch interfacing the air supply and the at least one control cylinder of the positioning mechanism such that, when the toggle switch is opened, the cylinders extend and are held extended by a pressure against gravity and cable tension.

6. The weight balancing gantry as claimed 3, further comprising a controlled solenoid interfacing a valve between the supply and the at least one control cylinder of the positioning mechanism for positioning the bogey at various positions along the length of the radial arm.

7. The weight balancing gantry as claimed in claim 1, wherein the weight balancing mechanism comprises counteracting weight balancing pulleys

8. The weight balancing gantry as claimed in claim 7, wherein the weight balancing pulleys are pneumatically biased from distal ends of respective pneumatic cylinders.

9. The weight balancing gantry as claimed in claim 8, wherein the pneumatic cylinders are collinear.

10. The weight balancing gantry as claimed in claim 8, further comprising a pressurised tank operably coupled to the pneumatic cylinders and wherein the gantry further comprises a pressure control mechanism to control the pressure of the pressurised tank according to the weight of the industrial tool.

11. The weight balancing gantry as claimed 1, wherein the angle strut comprises a gas strut.

12. The weight balancing gantry as claimed 11, wherein a force rating of the gas strut is such that, when the tool is at the proximal position, the gas strut is able to raise the radial arm.

13. The weight balancing gantry as claimed 11, wherein a force rating of the gas strut is such that, when the tool is at the distal position, the gas strut is unable to hold up the radial arm up.

14. The weight balancing gantry as claimed in claim 11, wherein the pneumatic cylinder of the angle strut is controlled.

15. The weight balancing gantry as claimed in claim 14, wherein the pneumatic cylinder is controlled from a controller accessible at the industrial tool.

16. The weight balancing gantry as claimed in claim 1, wherein the positioning mechanism comprises two hydraulic cylinder acting in series between the radial arm of the bogey.

17. The weight balancing gantry as claimed in claim 16, wherein a piston rod of a proximal cylinder of the positioning mechanism is connected to the cylinder tube of a distal cylinder of the positioning mechanism.

18. A method of controlling the weight balancing gantry as claimed in claim 1, the method comprising retracting the positioning mechanism to position the industrial tool at the lower proximal stowed position and extending the positioning mechanism to position the industrial tool at a distal raised deployed position.

19. A method of controlling the weight balancing gantry as claimed in claim 18, further comprising using the angle strut to raise the radial arm to hold the industrial tool over an elevated obstacle and to lower the radial arm to hold the industrial tool under an overhanging obstacle.

20. The method of controlling the weight balancing gantry as claimed in claim 19, wherein the angle strut comprises a gas strut having a force rating sufficient to raise the radial arm when the tool is at the proximal position and insufficient to hold the radial arm up when the tool is at the distal position and wherein the method further comprises raising and lowering the radial arm by controlling the position of the bogey.
